(19) United States
(12) Patent Application Publication
(10) Pub. No.: US 2011/0221859 A1
(43) Pub. Date: Sep. 15, 2011

(54) METHOD AND APPARATUS FOR VIDEO TELEPHONY IN MOBILE COMMUNICATION SYSTEM

(75) Inventor: Hong-Rae CHO, Bucheon-si (KR)

(73) Assignee: SAMSUNG ELECTRONICS CO. LTD., Suwon-si (KR)

(21) Appl. No.: 13/043,901

(22) Filed: Mar. 9, 2011

(30) Foreign Application Priority Data
Mar. 9, 2010 (KR) 10-2010-0020683

(51) Int. Cl. H04N 7/14

(52) U.S. Cl. 348/14.02; 348/E07.078

(57) ABSTRACT

A method and an apparatus for video telephony in a mobile communication system are provided. The video telephony method of a mobile communication terminal includes establishing a video telephony connection with an opponent terminal, transmitting at least one first vibration pattern supported by the terminal and a first vibration indicator corresponding to the at least one first vibration pattern, to the opponent terminal, and transmitting a first vibration indicator corresponding to one of the at least one first vibration pattern to the opponent terminal.

### PRIORITY

This application claims the benefit under 35 U.S.C. §119(a) of a Korean patent application filed in the Korean Intellectual Property Office on Mar. 9, 2010, and assigned Serial No. 10-2010-0020683, the entire disclosure of which is hereby incorporated by reference.

### BACKGROUND OF THE INVENTION

1. Field of the Invention

The present invention relates to a method and an apparatus for video telephony in a mobile communication system. More particularly, the present invention relates to a method and an apparatus for video telephony by sharing vibration pattern data between mobile communication terminals in video telephony.

2. Description of the Related Art

The International Mobile Telecommunications (IMT)-2000 system, which is adopted as a 3rd generation mobile communication system, builds a global wireless telephone network and enables unspecified individuals to use a wireless telephone all over the world using mobile communication terminals. Recently, the IMT-2000 system also provides a video telephony service.

A terminal using the video telephony service of the IMT-2000 system exchanges a video stream with another terminal over a network such as a packet switched network or a circuit switched network. To control the data, the H.245 protocol is commonly used. The H.245 protocol sends and receives control messages to improve the performance and channel between the terminals, and defines a terminal capability exchange, the opening and closing of a logical channel, preference mode requests, a flow control, and general commands and instructions by sending and receiving the control message.

A conventional video telephony service can transmit video and voice data in a predefined data format following those procedures. The maximum capacity of the data transmittable by the sending and receiving terminals is 64 kbps. The video, voice, and control data should be transmitted and received within 64 kbps. Naturally, the conventional video telephony service is using fixed bandwidths of 48 kbps, 12 kbps, and 4 kbps for the video, voice and control data. When the fixed bandwidth is not completely filled, stuffing data is used.

As discussed above, the conventional video telephony service sends and receives only the video and the voice, but does not satisfy a user's demand for improved service in accordance with latest mobile communication terminals which provide various functions.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for video telephony in a mobile communication system.

Another aspect of the present invention is to provide a method and an apparatus for sharing vibration pattern data between mobile communication terminals in video telephony in a mobile communication system.

Yet another aspect of the present invention is to provide a method and an apparatus of a mobile communication terminal for sharing vibration pattern data in video telephony using a control data region or a stuffing data region in a bandwidth provided from a vide telephony protocol.

According to an aspect of the present invention, a method for video telephony of a terminal in a mobile communication system is provided. The method includes establishing a video telephony connection with an opponent terminal, transmitting at least one first vibration pattern supported by the terminal and a first vibration indicator corresponding to the at least one first vibration pattern, to the opponent terminal, and transmitting a first vibration indicator corresponding to one of the at least one first vibration pattern to the opponent terminal.

According to another aspect of the present invention, an apparatus for video telephony of a terminal in a mobile communication system is provided. The apparatus includes a communication module for establishing a video telephony connection with an opponent terminal and for sending and receiving signals to and from the opponent terminal, and a controller for transmitting at least one first vibration pattern supported by the terminal and a first vibration indicator corresponding to the at least one first vibration pattern, to the opponent terminal, and for transmitting a first vibration indicator corresponding to one of the at least one first vibration pattern to the opponent terminal.

According to still another aspect of the present invention, a method for video telephony of a terminal in a mobile communication system is provided. The method includes establishing a video telephony connection with an opponent terminal, determining if at least one shared vibration pattern exists in the terminal and the opponent terminal, and if the at least one shared vibration pattern exists in the terminal and the opponent terminal, transmitting a vibration indicator corresponding to one of the at least one shared vibration pattern to the opponent terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a mobile communication system according to an exemplary embodiment of the present invention;

FIG. 2 illustrates a mobile communication terminal in a mobile communication system according to an exemplary embodiment of the present invention;

FIG. 3 illustrates signal flows for sharing, sending and receiving a vibration pattern between mobile communication terminals in a mobile communication system according to an exemplary embodiment of the present invention;

FIG. 4 illustrates signal flows for sending and receiving a vibration pattern between mobile communication terminals sharing the vibration pattern in advance in a mobile communication system according to an exemplary embodiment of the present invention; and

FIG. 5 illustrates a method for sharing, sending and receiving a vibration pattern in a mobile communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a method and an apparatus for sharing vibration pattern data between mobile communication terminals during video telephony in a mobile communication system. Hereinafter, descriptions on capability information, logical channel information exchange and negotiation, and master and slave determination between video telephony terminals shall be omitted to ease the understanding. It should be appreciated that those typical procedures are fulfilled in the video telephony.

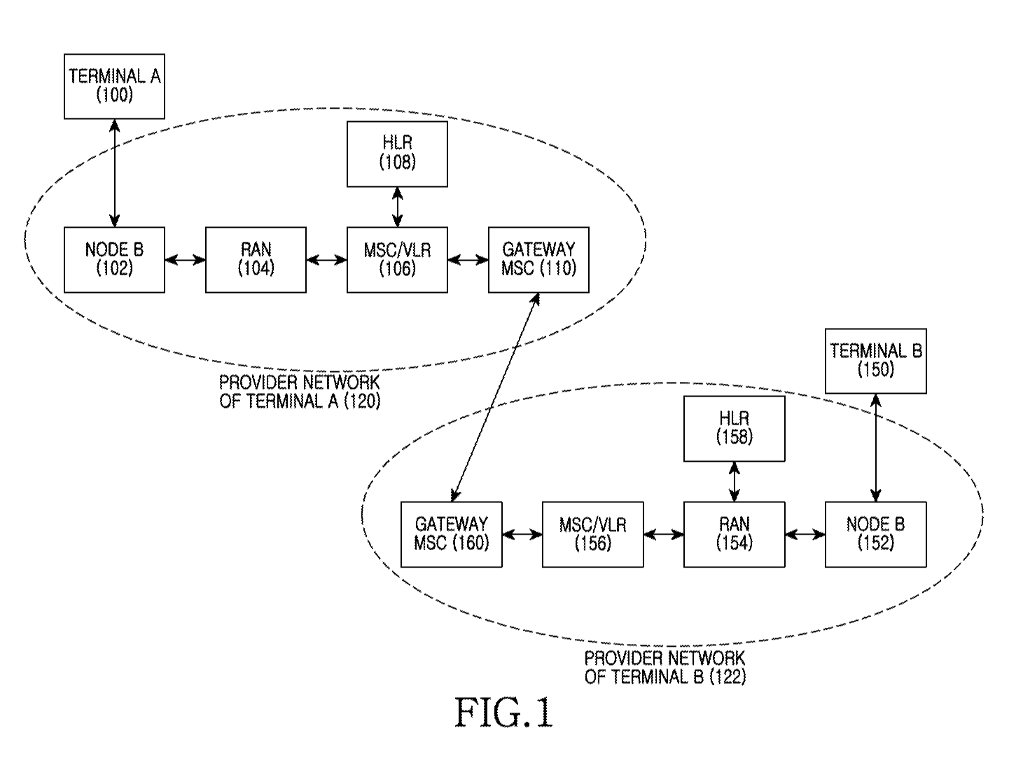

FIG. 1 illustrates a mobile communication system according to an exemplary embodiment of the present invention.

Referring to FIG. 1, the mobile communication system includes a terminal A 100 and a terminal B 150 for video telephony, a provider network 120 including the terminal A 100, and a provider network 122 including the terminal B 150. The provider networks 120 and 122 each include a node B 102 and 152, a Radio Access Network (RAN) 104 and 154, a Mobile Switching Center (MSC)/Visitor Location Register (VLR) 106 and 156 (hereafter, referred to as the MSC), a Home Location Register (HLR) 108 and 158, and a gateway MSC 110 and 160.

When the video telephony is attempted, the terminal A 100 and the terminal B 150 send and receive signals for the video telephony over the provider networks 120 and 122. For example, the terminal A 100 and the terminal B 150 exchange and negotiate capability information and logical channel information, and determine a master and a slave. More particularly, the terminal A 100 and the terminal B 150 determine whether the opponent terminal supports a vibration function in the video telephony, exchange vibration pattern information, and send to the opponent terminal a vibration indicator corresponding to the vibration pattern to transmit to the opponent terminal during the video telephony.

The node Bs 102 and 152, which function as base stations, each provide a wireless communication service to the terminal A 100 and the terminal B 150. The RANs 104 and 154, which are the subsystem of the node Bs 102 and 152, manage extensive tasks including access to a public switched telephone network and Internet, roaming, transparent connection, and service quality management for data and web connection, for 3rd generation mobile communication users.

The MSCs 106 and 156, which are mobile communication switches for providing the mobile communication service to the terminal A 100 and the terminal B 150, provide circuit switching between subscribers, input and output relay calls, handoffs, and roaming, and manage a database for the VLR.

The HLRs 108 and 108, which are databases for managing current location information of the terminals, status of the mobile communication subscribers, statistics, and service related information, provide various additional functions such as short message service and authentication service, and an interworking function with other switch functions.

The gateway MSCs 110 and 160 enable the communication networks to exchange information by accessing two or more heterogeneous or homogeneous communication networks.

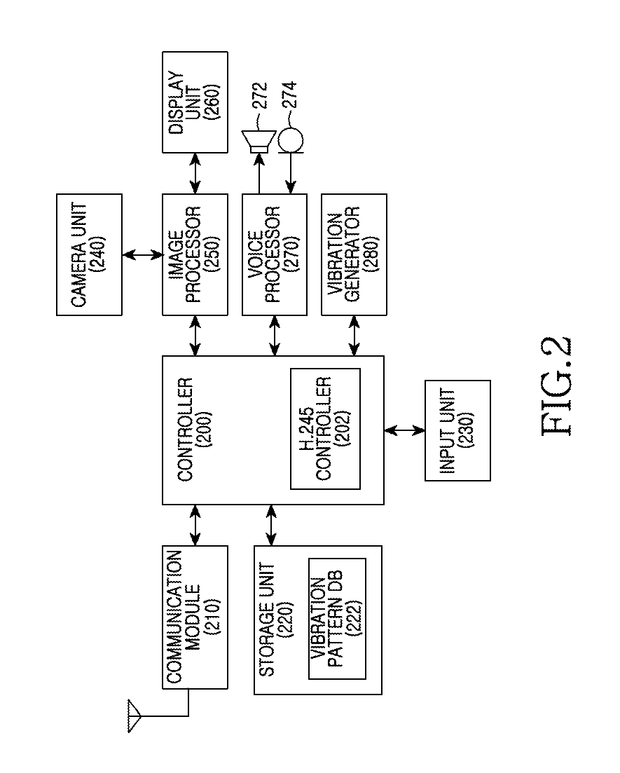

FIG. 2 illustrates a mobile communication terminal in a mobile communication system according to an exemplary embodiment of the present invention.

Referring to FIG. 2, the mobile communication terminal includes a controller 200, a communication module 210, a storage unit 220, an input unit 230, a camera unit 240, an image processor 250, a display unit 260, a voice processor 270, a speaker 272, a microphone 274, and a vibration generator 280. The controller 200 includes a H.245 controller 202. The storage unit 220 includes a vibration pattern DataBase (DB) 222.

The controller 200 processes and controls voice telephony and data communication of the mobile communication terminal. More particularly, when a video telephony event takes place, the controller 200 examines, using the H.245 protocol through the H.245 controller 202, whether the opponent terminal supports the vibration function during the video telephony. When the opponent terminal supports the vibration function during the video telephony, the controller 200 controls to share vibration pattern information with the opponent information. The H.245 controller 202 controls to send the vibration pattern information and the vibration indicator to the opponent terminal in the video telephony using a control data region or a stuffing data region of video, voice, control data and stuffing data regions that are defined in the H.245 protocol.

More specifically, in the video telephony, the controller 200 examines whether the opponent terminal supports the vibration function during the video telephony by sending and receiving a request message inquiring about whether the vibration function is supported during the video telephony, and a response message to and from the opponent terminal using the H.245 protocol. When the opponent terminal does not support the vibration function during the video telephony, the controller 200 controls to perform the video telephony by sending and receiving voice and images as in the conventional service. When the opponent terminal supports the vibration function during the video telephony, the controller 200 controls to send and receive voice, images, and the vibration pattern to and from the opponent terminal. That is, when the opponent terminal supports the vibration function during the video telephony, the controller 200 controls and processes to send the vibration pattern information stored to the vibration pattern DB 222 of the storage unit 220, that is, a plurality of vibration patterns and the corresponding vibration indicator information to the opponent terminal, to receive the vibration pattern information of the opponent terminal from the opponent terminal, and to store the vibration pattern information to the vibration pattern DB 222. Next, when an event for sending a particular vibration pattern to the opponent terminal is generated, the controller 200 controls and processes to send the vibration indicator corresponding to the vibration pattern to send, to the opponent terminal. When receiving the vibration indicator from the opponent terminal, the controller 200 confirms the corresponding vibration pattern in the vibration pattern DB 222 and provides the corresponding vibration pattern to the vibration generator 280.

The communication module 210, under the control of the controller 200, sends and receives radio signals of the input and output data over an antenna.

The storage unit 220 stores programs and data for the operations of the mobile communication terminal. The storage unit 220 includes the vibration pattern DB 222 for storing the vibration pattern information per terminal. Herein, the vibration pattern information includes the plurality of the vibration patterns and the vibration indicators corresponding to the vibration patterns. The plurality of vibration patterns implies that a vibrator vibrates according to different strengths or times. For example, the vibration pattern 1 can indicate that the vibrator vibrates at the strength V1 for the time T1, and the vibration pattern 2 can indicate that the vibrator repeatedly vibrates at the strength V1 for the time T2 and then at the strength V2 for the time T1. The vibration pattern DB 222 can store the vibration pattern information by classifying it based on the terminal. For example, the vibration pattern DB 222 can be divided into a DB for storing the vibration pattern information of the mobile communication terminal, a DB for storing the vibration pattern information received from the opponent terminal A, and a DB for storing the vibration pattern information received from the opponent terminal B.

The input unit 230 can be implemented using a keypad including at least one of function keys, number keys, and character keys, or using a touch sensor for detecting a user's touch. The input unit 230 detects a key press or a touch and provides the controller 200 with the corresponding data or coordinates.

The camera unit 240 includes a camera sensor for converting an optical signal detected when the image is captured, to an electrical signal, and a signal processor for converting an analog image signal from the camera sensor to digital data. The camera unit 240 outputs the digital video signal data to the image processor 250.

The image processor 250, which is also called a video COder-DECoder (CODEC), codes the image signal in a defined manner or decodes the coded frame image data to the original frame image data. The image processor 250 outputs the image signal fed from the camera unit 240 or the controller 200 according to characteristics and size of the display unit 260.

The display unit 260 displays status information, numbers, characters, still images, and videos generating in the operations of the mobile communication terminal.

The voice processor 270, which is also called a voice CODEC, inputs and outputs the voice signal through the speaker 272 and the microphone 274.

The vibration generator 280, which includes at least one vibrator, generates the vibration in the vibration pattern provided from the controller 200.

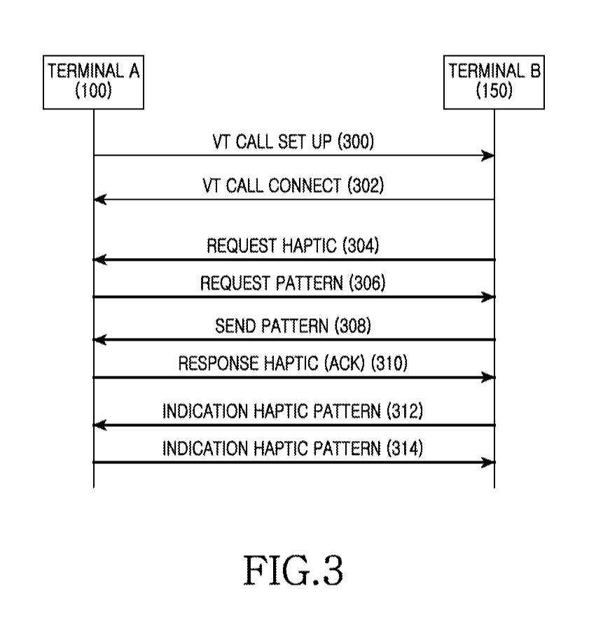

FIG. 3 illustrates signal flows for sharing, sending and receiving a vibration pattern between mobile communication terminals in a mobile communication system according to an exemplary embodiment of the present invention.

Referring to FIG. 3, when attempting a call connection for the video telephony, a terminal A 100 requests a Video Telephony (VT) call setup to an opponent terminal B 150 in step 300. Depending on a response of the terminal B 150, the VT call is connected in step 302.

When the VT call is connected, the terminal B 150 sends a request message inquiring about whether the vibration function is supported during the video telephony to determine whether the terminal A 100 supports the vibration function during the video telephony in step 304. The terminal A 100 receiving the request message examines whether it supports the vibration function during the video telephony. When supporting the vibration function during the video telephony, the terminal A 100 sends a message requesting to send the vibration pattern information to the terminal B 150 in step 306. When not supporting the vibration function during the video telephony, the terminal A 100 sends to the terminal B 150 a response message indicating no support of the vibration function during the video telephony and thus sends and receives the voice and the video in the conventional manner.

When the terminal B 150 sends a message including its vibration pattern information to the terminal A 100 in step 308, the terminal A 100 stores the vibration pattern information received from the terminal B 150 and sends a response message indicating ACK in step 310. Herein, the terminal A 100 can send its vibration pattern information to the terminal B 150 in step 306 or step 310.

The terminal B 150 sends a particular vibration indicator to the terminal A 100 in step 312. The terminal A 100 receiving the vibration indicator from the terminal B 150 searches for the vibration pattern corresponding to the received particular vibration indicator from the pre-received vibration pattern information of the terminal B 150 and generates the vibration through at least one vibrator according to the searched vibration pattern. When the terminal A 100 sends a particular vibration indicator to the terminal B 150 in step 314, the terminal B 150 searches for the vibration pattern corresponding to the received particular vibration indicator from the pre-received vibration pattern information of the terminal A 100 and generates the vibration through the vibrator according to the searched vibration pattern.

The steps 304 through 310 are performed to make the terminal A 100 and the terminal B 150 determine whether they support the vibration function during the video telephony and send and share their vibration pattern information to the opponent terminal when the opponent terminal supports the vibration function during the video telephony. The steps 304 through 310 can be fulfilled in other manners. For instance, the terminal A 100 may first send the request message inquiring about whether the terminal B 150 supports the vibration function during the video telephony, the terminal receiving the request message inquiring about whether it supports the vibration function during the video telephony may send the response message indicating whether the vibration function is supported, and then the terminal A 100 and the terminal B 150 may send and receive the vibration pattern information.

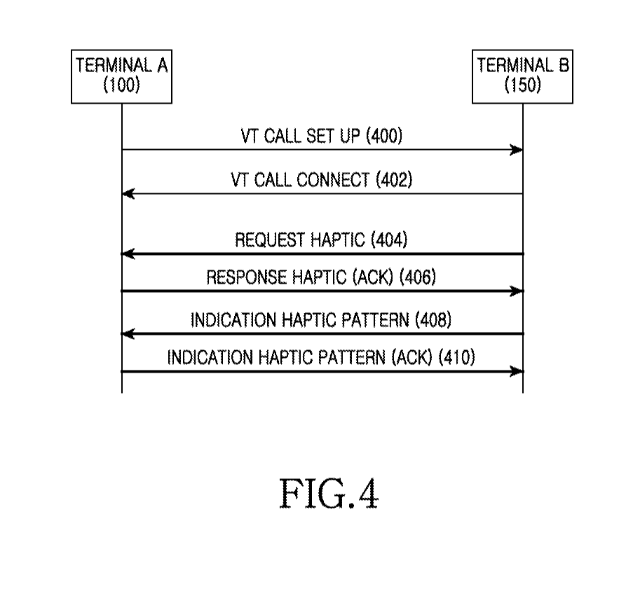

FIG. 4 illustrates signal flows for sending and receiving a vibration pattern between mobile communication terminals sharing the vibration pattern in advance in a mobile communication system according to an exemplary embodiment of the present invention.

Referring to FIG. 4, when attempting a call connection for the video telephony, the terminal A 100 requests the VT call setup to the opponent terminal B 150 in step 400. Depending on a response of the terminal B 150, the VT call is connected in step 402.

When the VT call is connected, the terminal B 150 sends a request message inquiring about whether the vibration function is supported during the video telephony to determine whether the terminal A 100 supports the vibration function during the video telephony in step 404. The terminal A 100 receiving the request message examines whether it supports the vibration function during the video telephony. When supporting the vibration function during the video telephony, the terminal A 100 sends a response message indicating ACK in step 406. Herein, since the terminal A 100 and the terminal B 150 pre-store the mutual vibration pattern information, the exchange of the vibration pattern information with the opponent terminal is omitted.

When the terminal B 150 sends a particular vibration indicator to the terminal A 100 in step 408, the terminal A 100 searches for the vibration pattern corresponding to the received particular vibration indicator from the pre-received vibration pattern information of the terminal B 150 and generates the vibration through the vibrator in the searched vibration pattern.

When the terminal A 100 sends a particular vibration indicator to the terminal B 150 in step 410, the terminal B 150 searches for the vibration pattern corresponding to the received particular vibration indicator from the pre-received vibration pattern information of the terminal A 100 and generates the vibration through the vibrator according to the searched vibration pattern.

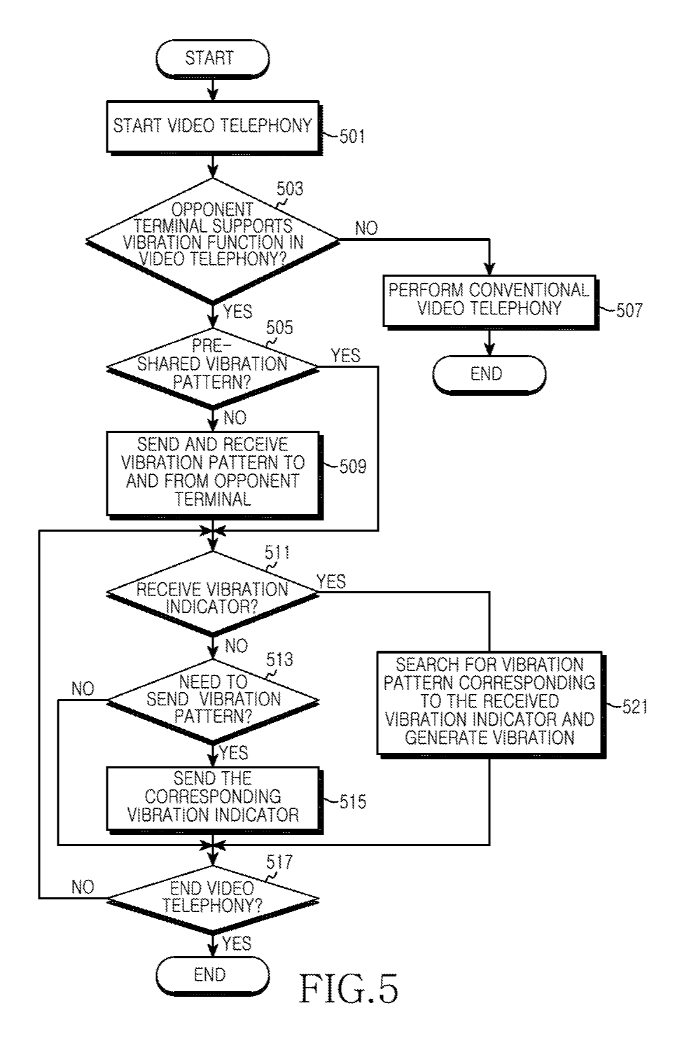

FIG. 5 illustrates a method for sharing, sending and receiving a vibration pattern in a mobile communication system according to an exemplary embodiment of the present invention.

Referring to FIG. 5, when the video telephony begins in step 501, the terminal determines whether the opponent terminal supports the vibration function during the video telephony in step 503. Herein, the terminal can determine whether the opponent terminal supports the vibration function during the video telephony by sending a request message inquiring about whether the vibration function is supported during the video telephony and receiving a response message, or by receiving from the opponent terminal a request message inquiring about whether the vibration function is supported during the video telephony.

If it is determined in step 503 that the opponent terminal does not support the vibration function during the video telephony, the terminal performs the video telephony in the conventional manner in step 507 and finishes this process.

In contrast, if it is determined in step 503 that the opponent terminal supports the vibration function during the video telephony, the terminal determines whether there is a pre-shared vibration pattern in step 505. For example, the terminal determines whether it performed the video telephony with the opponent terminal previously or has otherwise received the vibration pattern information from the opponent terminal Herein, the terminal may determine whether the storage unit 220 stores the pre-shared vibration pattern using the vibration pattern DB 222.

If it is determined in step 505 that the pre-shared vibration pattern is detected, the terminal proceeds to step 511. On the other hand, if it is determined in step 505 that there is no pre-shared vibration pattern, the terminal sends and receives the vibration pattern information to and from the opponent terminal in step 509. In so doing, the terminal stores the vibration pattern information of the opponent terminal received from the opponent terminal, to the vibration pattern DB 222 of the storage unit 220. Herein, the terminal sends and receives the vibration pattern information to and from the opponent terminal in the video telephony using the control data region or the stuffing data region of the video, voice, control data, and stuffing data regions defined in the H.245 protocol.

In step 511, the terminal determines whether the vibration indicator is received from the opponent terminal. If it is determined in step 511 that the vibration indicator is received from the opponent terminal, the terminal searches for the vibration pattern corresponding to the received vibration indicator from the pre-stored vibration pattern information of the opponent terminal and generates the vibration through the vibrator according to the searched vibration pattern in step 521.

In contrast, if it is determined in step 511 that no vibration indicator is received from the opponent terminal, the terminal determines whether it is necessary to send the vibration pattern in step 513. Herein, when a particular vibration pattern is generated by the user's key press or touch, the terminal can determine that it is necessary to send the vibration pattern.

If it is determined in step 513 that the transmission of the vibration pattern is unnecessary, the terminal proceeds to step 517. On the other hand, if it is determined in step 513 that the transmission of the vibration pattern is necessary, the terminal sends the vibration indicator corresponding to the vibration pattern to the opponent terminal in step 515. The terminal sends the vibration indicator to the opponent terminal of the video telephony using the control data region or the stuffing data region of the video, voice, control data, and stuffing data regions defined in the H.245 protocol. Herein, the vibration pattern to send indicates the vibration pattern corresponding to the key press or the touch. That is, the vibration patterns can be mapped to particular keys or touches respectively.

In step 517, the terminal determines whether a video telephony end event takes place. If it is determine in step 517 that the video telephony end event does not take place, the terminal returns to step 511. On the other hand, if it is determine in step 517 that the video telephony end event generates, the terminal finishes this process.

By sharing the vibration pattern data between the mobile communication terminals of the video telephony in the mobile communication system, it is possible to improve usability and satisfaction of the user and enhance the video telephony quality. In addition, limited video telephony resources can be overcome by using the conventional control data region or stuffing region.

While the invention has been shown and described with reference to certain exemplary embodiments thereof, it will be understood by those skilled in the art that various changes in form and details may be made therein without departing from the scope of the invention as defined by the appended claims and their equivalents.

What is claimed is:

1. A method for video telephony of a terminal in a mobile communication system, the method comprising:
establishing a video telephony connection with an opponent terminal;
transmitting at least one first vibration pattern supported by the terminal and a first vibration indicator corresponding to the at least one first vibration pattern, to the opponent terminal; and
transmitting a first vibration indicator corresponding to one of the at least one first vibration pattern to the opponent terminal.

2. The method of claim 1, further comprising:
receiving and storing at least one second vibration pattern supported by the opponent terminal and a second vibration indicator corresponding to the at least one second vibration pattern;
receiving a particular second vibration indicator from the opponent terminal;
searching for a vibration pattern corresponding to the particular second vibration indicator from the at least one second vibration pattern and the stored second vibration indicator; and
vibrating a vibrator according to the searched second vibration pattern.

3. The method of claim 1, wherein the at least one first vibration pattern and the first vibration indicator are transmitted using at least one of a control data region and a stuffing data region defined in the H.245 protocol.

4. The method of claim 1, wherein the one of the at least one first vibration pattern is generated through at least one of a key press of a keypad and a touch of a touch sensor.

5. The method of claim 1, further comprising:
determining whether the opponent terminal supports a vibration function in the video telephony.

6. The method of claim 1, further comprising:
determining whether there is a vibration pattern previously received from the opponent terminal,
wherein, when there is the previously received vibration pattern, the transmitting of the at least one first vibration pattern and the first vibration indicator to the opponent terminal is omitted and a vibration indicator corresponding to the certain vibration pattern is transmitted.

7. An apparatus for video telephony of a terminal in a mobile communication system, the apparatus comprising:
a communication module for establishing a video telephony connection with an opponent terminal and for sending and receiving signals to and from the opponent terminal; and
a controller for transmitting at least one first vibration pattern supported by the terminal and a first vibration indicator corresponding to the at least one first vibration pattern, to the opponent terminal, and for transmitting a first vibration indicator corresponding to one of the at least one first vibration pattern to the opponent terminal.

8. The apparatus of claim 7, further comprising:
a storage unit for storing at least one second vibration pattern supported by the opponent terminal and a second vibration indicator corresponding to the at least one second vibration pattern, which are received through the communication module; and
at least one vibrator for vibrating in a vibration pattern,
wherein the controller searches for a vibration pattern corresponding to a particular second vibration indicator received from the opponent terminal, in the storage unit, and controls the vibrator to vibrate according to the searched second vibration pattern.

9. The apparatus of claim 7, wherein the at least one first vibration pattern and the first vibration indicator are transmitted using at least one of a control data region and a stuffing data region defined in the H.245 protocol.

10. The apparatus of claim 7, further comprising:
an input unit comprising at least one of a keypad and a touch sensor,
wherein the controller detects a certain vibration pattern through at least one of a key press of the keypad and a touch of the touch sensor, and controls to send a vibration indicator corresponding to one of the at least one first vibration pattern to the opponent terminal.

11. The apparatus of claim 7, wherein the controller determines whether the opponent terminal supports a vibration function in the video telephony.

12. The apparatus of claim 7, wherein the controller determines whether there is a vibration pattern previously received from the opponent terminal, and when there is the previously received vibration pattern, omits to send the at least one first vibration pattern and the first vibration indicator to the opponent terminal and controls to send a vibration indicator corresponding to the vibration pattern to send.

13. A method for video telephony of a terminal in a mobile communication system, the method comprising:
establishing a video telephony connection with an opponent terminal;
determining if at least one shared vibration pattern exists in the terminal and the opponent terminal; and
if the at least one shared vibration pattern exists in the terminal and the opponent terminal, transmitting a vibration indicator corresponding to one of the at least one shared vibration pattern to the opponent terminal.

14. The method of claim 13, further comprising:
if the at least one shared vibration pattern does not exist in the terminal and the opponent terminal, at least one of transmitting and receiving the at least one shared vibration pattern to and from the opponent terminal; and
transmitting a vibration indicator corresponding to one of the at least one shared vibration pattern to the opponent terminal.

15. The method of claim 14, wherein the at least one shared vibration pattern is at least one of transmitted and received using at least one of a control data region and a stuffing data region defined in the H.245 protocol.

16. The method of claim 13, further comprising:
receiving a vibration indicator from the opponent terminal;
searching for a vibration pattern corresponding to the vibration indicator from among the at least one shared vibration pattern; and
vibrating a vibrator according to the searched vibration pattern.

17. The method of claim 13, wherein the one of the at least one shared vibration pattern is generated through at least one of a key press of a keypad and a touch of a touch sensor.

18. The method of claim 13, further comprising:
determining whether the opponent terminal supports a vibration function in the video telephony.
